(19) United States
(12) Patent Application Publication
(10) Pub. No.: US 2011/0132272 A1
(43) Pub. Date: Jun. 9, 2011

(54) DISPOSABLE CAGE

(76) Inventors: George S. GABRIEL, Seaford, DE (US); Neil E. CAMPBELL, Eden, MD (US); Rodney E. GERRINGER, Forest Hill, MD (US); Edward K. ELDRETH, Port Deposit, MD (US); Lynn IRWIN, Laurel, DE (US); Chinsoo PARK, Salisbury, MD (US)

(21) Appl. No.: 12/940,378

(22) Filed: Nov. 5, 2010

Related U.S. Application Data
(60) Provisional application No. 61/258,693, filed on Nov. 6, 2009.

(51) Int. Cl. A01K 1/035; A01K 1/00; A01K 39/00

(52) U.S. Cl. 119/456; 119/475; 119/480

(57) ABSTRACT

A disposable rodent cage used in both static and/or ventilated cage and rack systems, wherein the disposable cage includes a cage bottom. The cage may further be provided with a grommet disposed on the cage bottom and a bonnet constructed and arrange to fit over the cage bottom. The bonnet may further include a feeding and watering assembly. The cage may further include a filter cover that may be placed over an opening in the bonnet to cover the feeding and watering assembly. The bonnet may also include one or more elevated ribs disposed thereon to create an air seal when it is inserted into a canopy of a rack.

### CROSS REFERENCE TO RELATED APPLICATIONS

This application claims priority to U.S. Provisional Patent Application No. 61/258,693, filed Nov. 6, 2009, entitled “DISPOSABLE CAGE,” the entirety of which is hereby incorporated by reference herein.

### BACKGROUND OF THE INVENTION

This invention relates generally to a rodent cage which may be used as a static cage or in connection with ventilated cage and rack systems and, in particular, to a disposable rodent cage that may be used for a variety of rodent types including, but not limited to, rats, mice, gerbils, hamsters and guinea pigs.

High density ventilated cage and rack systems are well known in the art. One such ventilated cage and rack system is disclosed in U.S. Pat. No. 5,954,013, assigned to Lab Products, Inc. which is incorporated by reference as if fully set forth herein, in which an open rack system including a plurality of shelves formed to support a cage and that includes an exhaust air plenum is disclosed. The ventilation system disclosed therein is connected to the rack system for ventilating each cage in the rack. In such prior art ventilated cage and rack systems, cages of different sizes are used to accommodate rodents of different types. Each of these cages are made of certain autoclavable materials such as molded polycarbonates and polysulfones, and other synthetic materials that are heavier and durable and require considerable energy to mold. These cages are reused for years to house rodents and other species therein during laboratory experiments and studies.

Part of the normal protocol of such experiments and studies is to periodically remove the rodents from each cage in a workbench environment and to transfer the mice to a clean cage. Dirty cages are then sent to a washroom where they are washed, autoclaved and sterilized so that they can be reused numerous times over several years. However, a disadvantage of these polycarbonate cages is that they will often retain bacteria or toxins that can be problematic and could affect the efficacy of the studies performed using these rodents. Secondly, the cost of maintaining expensive washrooms and personnel to handle cages, to autoclave the cages, as well as the cost of maintaining a large inventory of cages and transporting the cages becomes a considerable cost of the study.

Accordingly, a disposable cage that could be used as a static unit or in connection with a ventilated cage and rack system and that is formed from a material that is sufficiently inexpensive to manufacture and that will require little energy to recycle, and yet provides all of the benefits of a traditional cage is desirable.

It should be noted that although the below description describes the device, system, and/or method of the present invention being a disposable cage for use with ventilated cage and rack systems, it can be appreciated by one of ordinary skill in the art that certain aspects of the present invention can be used in conjunction with other products such as Lab Products' See-Through™ Systems which may include a rack and shelves.

### SUMMARY OF THE INVENTION

One embodiment of the present invention is directed to a rodent cage including a cage bottom made from a disposable material, such as clarified polypropylene having a plurality of integral sidewalls, a floor and an open top end. In certain embodiments, a grommet, with or without a flap, may also be provided to enable air and/or water to pass into the cage.

In one embodiment, a bonnet configuration that may be made from disposable material such as clarified polypropylene and that may include a feeding assembly and watering assembly integrally molded into the bonnet, may also be provided.

In one embodiment, a filter cover may further be provided. The filter cover may be disposed over the feeding and watering assembly to seal off the watering and feeding assembly and thereby provide a barrier level rodent cage.

Thus, it is an object of the invention to provide a disposable cage for an animal.

Another object of the invention is to provide a disposable cage for use in both static and/or ventilated cage and rack systems applications.

Additional features and advantages of embodiments of the present invention are described further below. This summary section is meant merely to illustrate certain features of the invention, and is not meant to limit the scope of the invention in any way. The failure to discuss a specific feature or embodiment of the invention, or the inclusion of one or more features in this summary section, should not be construed to limit the invention as claimed.

### BRIEF DESCRIPTION OF THE DRAWINGS

A further understanding of the present invention can be obtained by reference to a preferred embodiment set forth in the illustrations of the accompanying drawings. Although the illustrated embodiment is merely exemplary of systems for carrying out the present invention, both the organization and method of operation of the invention, in general, together with further objectives and advantages thereof, may be more easily understood by reference to the drawings and the following description. The drawings are not intended to limit the scope of this invention, which is set forth with particularity in the claims as appended or as subsequently amended, but merely to clarify and exemplify the invention.

For a fuller understanding of the invention, reference is had to the following description taken in connection with the accompanying drawings, in which:

FIG. 1 is a perspective view of a single disposable cage of one embodiment of the present invention;

FIG. 2 is a perspective view of a single disposable cage of one embodiment of the present invention;

FIG. 3 is a side view of a single disposable cage with a bonnet of one embodiment of the present invention;

FIG. 4 is an end view of a single disposable cage with a bonnet of one embodiment of the present invention;

FIG. 5 is a perspective view of a bonnet and filter cover and cage bottom constructed in accordance with one embodiment of the present invention;

FIG. 6A is a top perspective view of a bonnet configured to fit over a cage bottom in accordance with one embodiment of the present invention;

FIG. 6B is a perspective view of a bonnet configured to fit over a cage bottom in accordance with one embodiment of the present invention;

FIG. 7A is a bottom perspective view of a bonnet configured to fit over a cage bottom in accordance with one embodiment of the present invention;

FIG. 7B is another bottom perspective view of a bonnet configured to fit over a cage bottom in accordance with one embodiment of the present invention;

FIG. 7C is another bottom perspective view of a bonnet configured to fit over a cage bottom in accordance with one embodiment of the present invention;

FIG. 8 is a perspective view of a filter cover in accordance with one embodiment of the present invention;

FIG. 9 is a bottom view of a filter cover in accordance with one embodiment of the present invention;

FIG. 10 is a perspective view of a single cage in accordance with one embodiment of the present invention positioned in a ventilated rack system under a canopy with a cage lock in the locked position;

FIG. 11 is a top view of a bonnet and filter cover in accordance with one embodiment of the present invention; and

FIG. 12 is a perspective view of a portion of the interior of the disposable cage in accordance with one embodiment of the present invention;

FIG. 13 is a side view of a bonnet in accordance with one embodiment of the present invention;

FIG. 14 is a side view of a cage bottom in accordance with one embodiment of the present invention;

FIG. 15 is a perspective view of a first piece of an air grommet in accordance with one embodiment of the present invention;

FIG. 16 is a perspective view of a second piece of an air grommet in accordance with one embodiment of the present invention;

FIG. 17 is a perspective view of a flap grommet in accordance with one embodiment of the present invention;

FIG. 18 is a perspective view of an exterior piece of a flap grommet in accordance with one embodiment of the present invention;

FIG. 19 is a perspective view of an interior piece and a flap door of a flap grommet in accordance with one embodiment of the present invention; and

FIG. 20 is a cross-sectional perspective view of a single cage in accordance with one embodiment of the present invention, wherein the cage is positioned in a ventilated rack system.

### DETAILED DESCRIPTION OF THE PREFERRED EMBODIMENTS

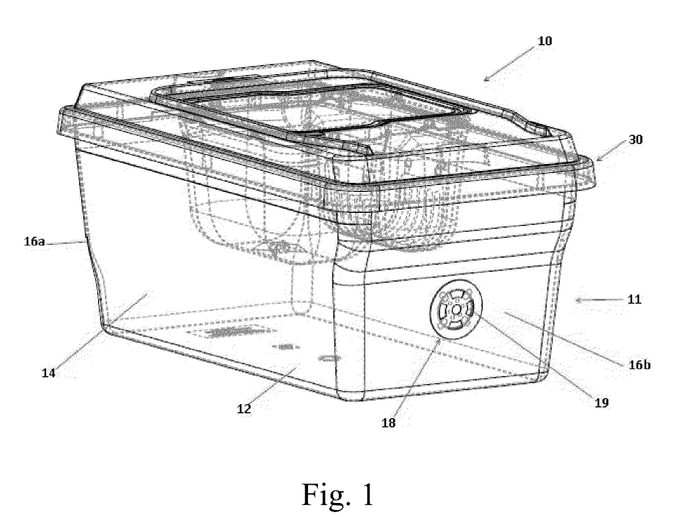

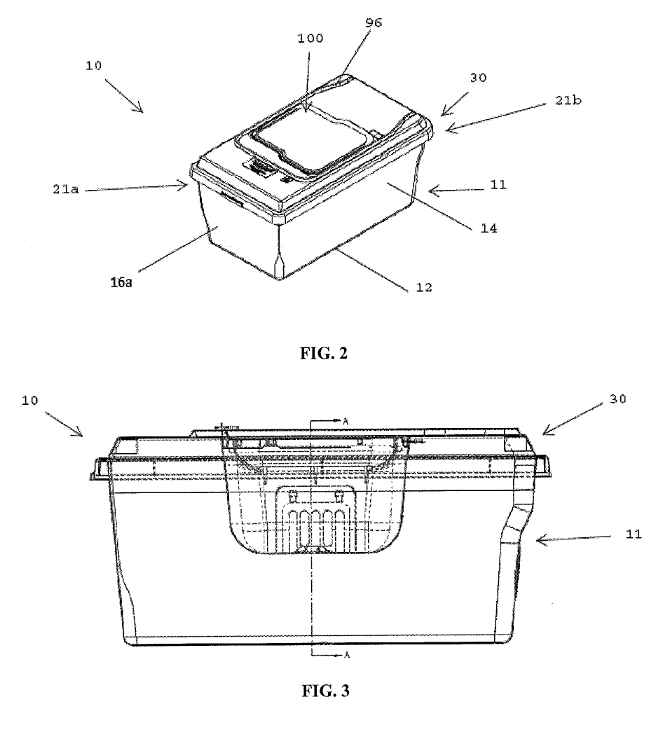

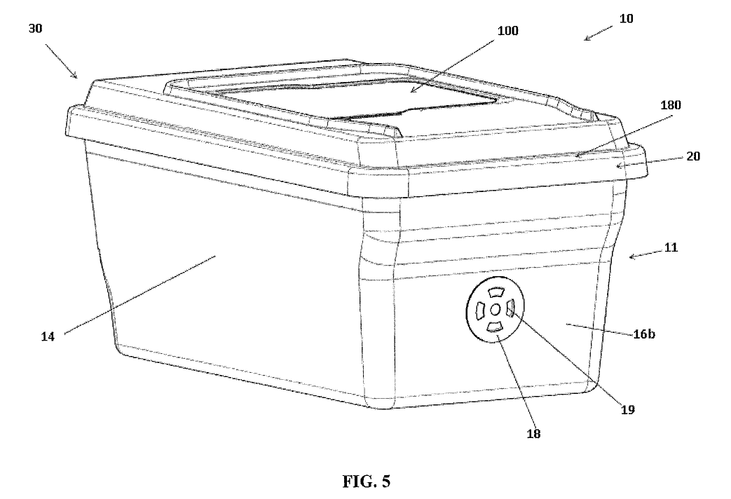

Reference is made to FIGS. 1, 2, 5, 10, 12, and 20 wherein a disposable cage assembly generally indicated at 10 and constructed in accordance with one embodiment the instant invention is depicted. In one embodiment, the disposable cage 10 includes a cage bottom 11 made of clarified polypropylene having a bottom wall 12, a sidewall 14, and end walls 16a, 16b that together form a cage bottom 11. In another embodiment, the disposable cage 10 includes a cage bottom 10, a grommet 18, 500, a bonnet configuration 30, and a filter cover 100.

As shown in FIG. 1, certain embodiments of the cage bottom 11 may be used with high density rack systems and may include a stainless steel metal grommet 18 having air openings 19 therein. In other embodiments, the cage bottom 11 may be used in static applications, such as with Lab Products' See-Through™ System mentioned above. In some static applications, the cage 10 may include only the cage bottom 11, without a grommet 18, 500, bonnet configuration 30, or a filter top 100.

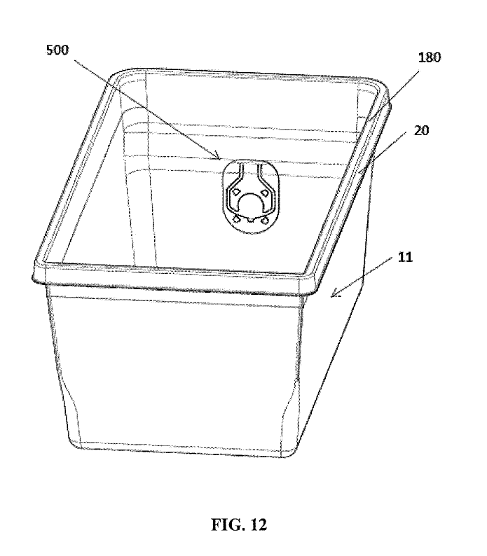

As shown in FIGS. 1, 2, 5, and 12, the peripheral wall of a static cage bottom is defined by side walls 14 and the end walls 16a, 16b have a continuous peripheral top wall 180 and a peripheral flange 20 (FIG. 12) that extends around the entire periphery of the cage bottom 11 and that extends downward to create a peripheral outer skirt wall for the cage bottom 11.

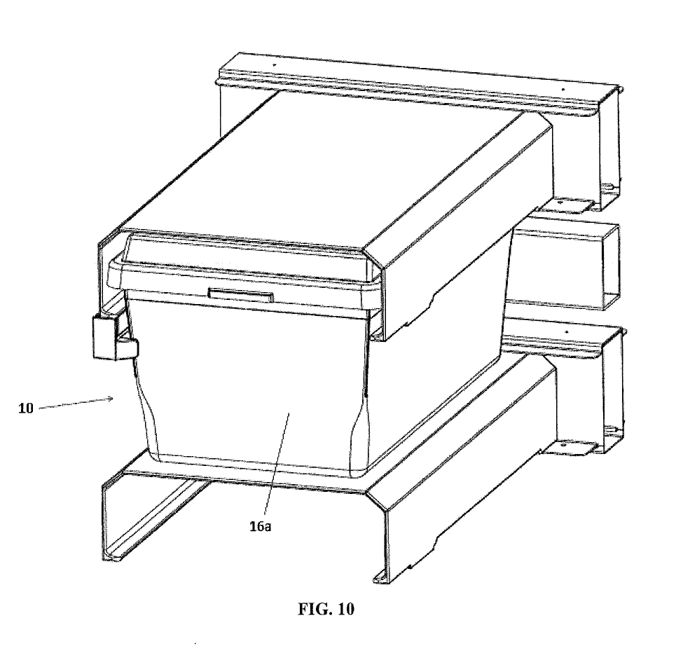

In one embodiment, the front of the cage bottom 11 may be defined by tightly radiused corners 21a and the back of the cage bottom 11 may be defined by larger radiused corners 21b. In one embodiment, this helps facilitate a proper fit with the bonnet configuration 30 (as described below) to ensure proper air flow through the cage 10. In one embodiment, the tighter front corners 21 a also enable the cage 10 to be used with a variety of cage locks, such as that shown in FIG. 10.

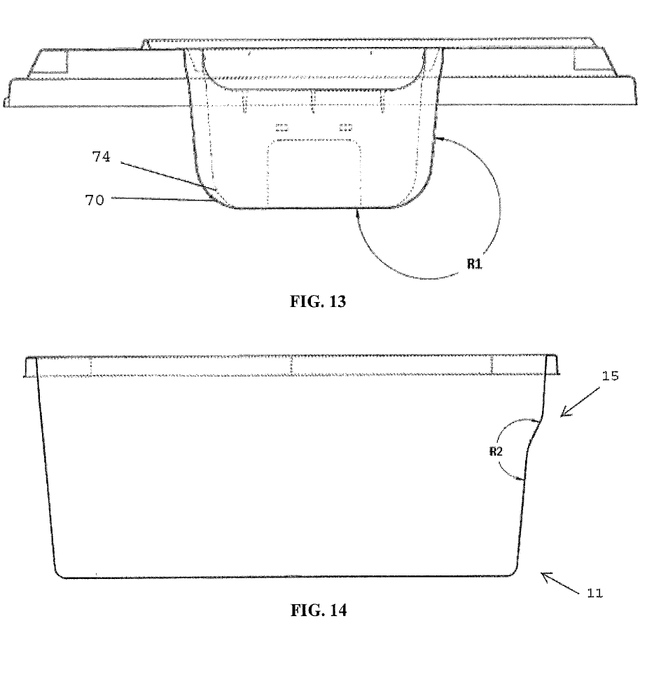

In one embodiment, the cage bottom 11 may include one or more internal corners. With reference to FIG. 14, internal corner 15 may be provided to contour the cage bottom to the desired shape. The internal corner may be preferably rounded and radiused to sufficiently prevent a caged animal from gripping and/or chewing on any portion of the cage bottom 11, as indicated by R2 in FIG. 14. The rounded internal corner 15 additionally facilitates mold release in manufacture.

In one embodiment, both the front and back corners 21a, 21b are substantially rounded to relieve the stress associated with sharp corners. Such rounded corners also make the manufacturing process more efficient as rounded corners facilitate ease of mold release.

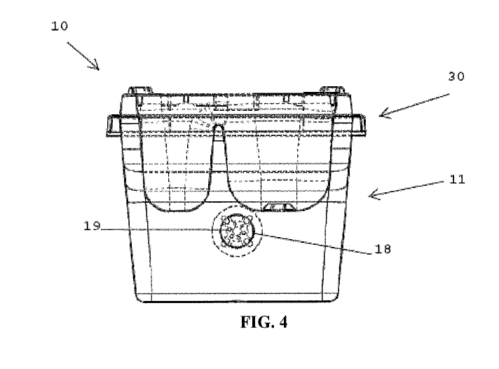

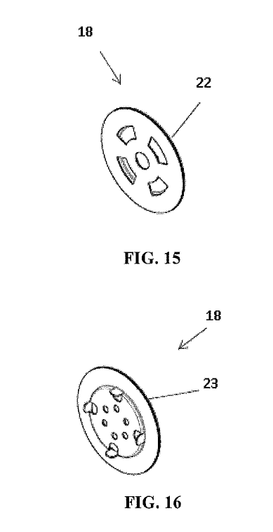

With reference to FIGS. 1, 4, 5, and 15-16, in one embodiment, the end wall 16b may include an air grommet 18 to permit the cage to be docked in a high-density rack. In one embodiment, the air grommet 18 may include a first piece 22 engagable to a second piece 23 (via weld points or tabs or any other engagement or affixation device now known or later developed). When assembled in the cage 10, the first piece 22 may be disposed on the end wall 16b on the exterior of the cage bottom 11 and the second piece 23 may be disposed on the end wall 16b on the interior of the cage bottom 11, engaged to the first piece 22. In another embodiment, as can be appreciated by one of ordinary skill in the art, the air grommet 18 may be one integral piece so that back of first piece 22, and second piece 23 are formed together to avoid any complications that may arise from an air grommet formed of multiple pieces.

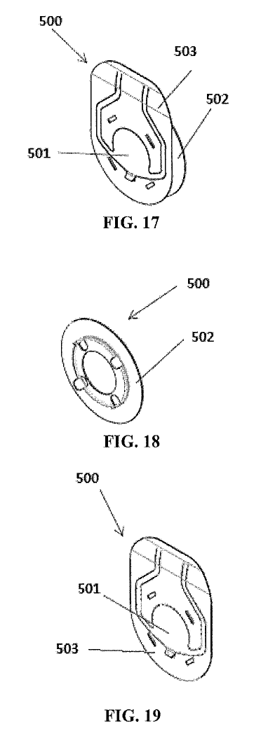

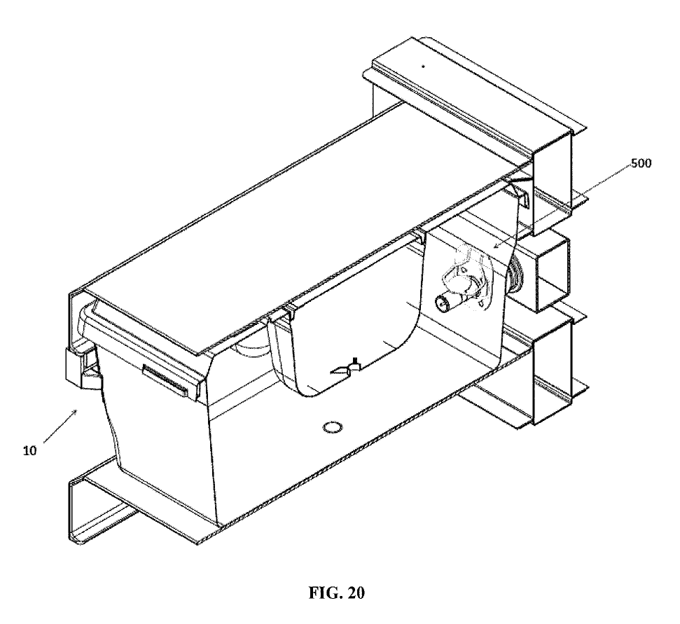

With reference to FIGS. 12 and 17-20, in one embodiment, the end wall 16b of the cage 10 may include a flap grommet 500 to enable cage 10 to be used with rack mounted valve automatic water systems (partially shown in FIG. 20). Flap grommet 500 may include an exterior piece 502 and an interior piece 503 having a displaceable flap door 501 (FIGS. 17-19). The exterior piece 502 may be engagable with the interior piece 503. When assembled in the cage 10, the exterior piece 502 may be disposed on the end wall 16b on the exterior of the cage bottom 11 and the interior piece 503 may be disposed on the end wall 16b on the interior of the cage bottom 11, engaged to the exterior piece 502. The flap door 501 may be displaceable into an open and closed position (see, e.g., FIGS. 12 and 20). In another embodiment, the flap grommet 500 may be provided as one integral piece. The flap grommet 500 may be made of spring grade stainless steel.

When the cage is placed into a rack, the flap door 501 of the flap grommet 500 may be displaced into an open position by a drinking valve (see, e.g., FIG. 20) from the automatic water system, enabling the drinking valve to pass through the center of the grommet 500 along with the cage supply air, permitting both water and air to pass into the cage bottom 11. When the drinking valve is removed, the flap door 501 may automatically close (see, e.g., FIG. 12). Thus, the cage 10 may be used with multiple types of animal water delivery systems, including pouches, bottles, or piped automatic drinking water delivery systems.

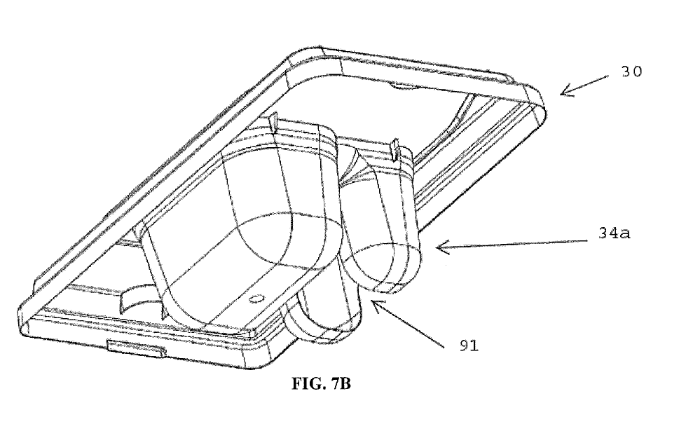

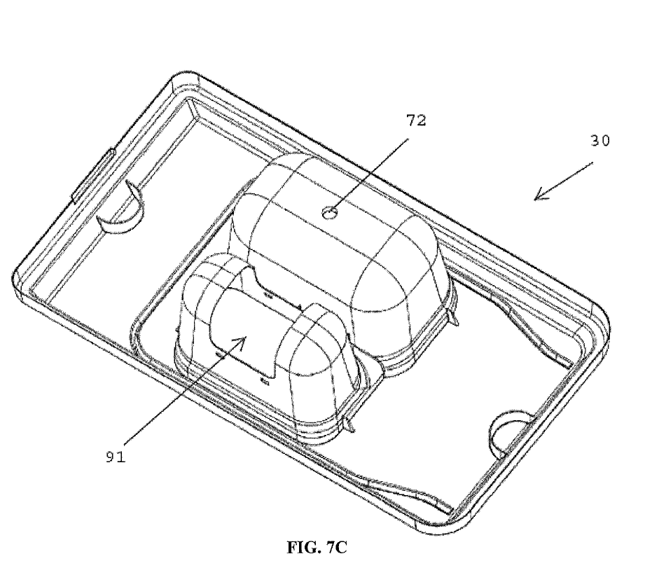

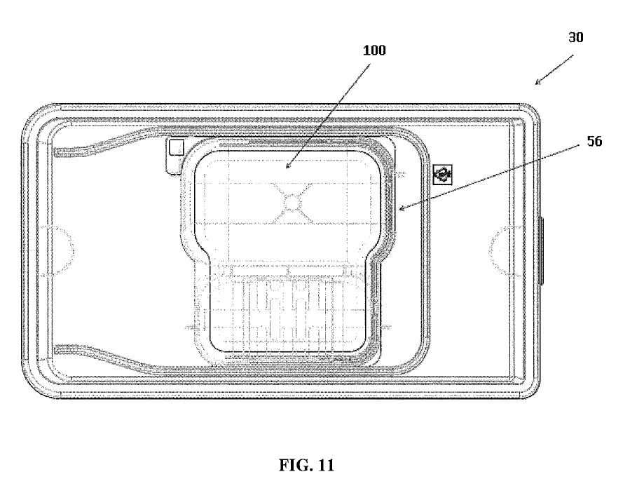

Referring next to FIGS. 1-7C, and 11, one embodiment of the bonnet configuration 30 may be made of clarified polypropylene and may include a top wall 32 that includes a feeding assembly, 34a, and a watering assembly, generally indicated as 34b, that may be integrally molded therein. Because the feeding assembly 34a and watering assembly 34b are integrally formed in the bonnet configuration 30, the bonnet configuration 30 may be removed from the cage bottom 11 with greater ease (for example, for cage cleaning or when working with the animal) and convenience as there are fewer loose parts to handle. The integral formation of the bonnet configuration 30 also permits a user to change or add food or water without removing the entire bonnet configuration 30 from the cage bottom 11.

In one embodiment, the bonnet 30 may additionally include an angled sidewall 36 that terminates in a flat wall 37 which extends to a continuous skirt 38 that surrounds the periphery thereof. The peripheral skirt 38 of the bonnet cover has tightly radiused corners 76 on the front end of the cage and larger radiused corners 77 on the back end of the cage to assure that the bonnet can be snugly positioned on the cage bottom in one orientation (i.e., in correspondence with 21a and 21b respectively). In one embodiment, the flat wall 37 and skirt 38 are adapted to rest upon the peripheral top wall 180 and peripheral flange 20 of the cage bottom 11 so that it snugly fits thereon to prevent the leakage of air between the bonnet 30 and cage bottom 11.

In one embodiment, the watering assembly 34b includes a molded water well 70 having an aperture 72 for receiving a water container, e.g., a bag of water or a water bottle. In an exemplary embodiment, a disposable bag of the type made by Hydropac/Lab Products, Inc. and disclosed and claimed in U.S. patent application Ser. No. 10/588,430 (U.S. Pat. Pub. No. 2008-0098961), filed Sep. 1, 2007, which is hereby incorporated by reference herein, would be preferred since the bag would be equally disposable along with the cage after it is used.

In one embodiment, feeder assembly 34a includes a molded feed well 74 having an opening 91 that receives a stainless steel closure 90 that provides a closure to the bottom of the feeder assembly and allows for food to be put into the feeder assembly. Closure 90 has slots 92 therein for permitting the rodents to withdraw the food through the slots and obtain food. In one embodiment, a minimum of four rows of slots 90 with two separate slots per row, with a minimum slot length of about 1 inch are provided. The slots are preferably aligned in a parallel configuration.

With reference to FIG. 13, the molded feed well 74 and the molded water well 70 may be formed in any suitable shape, e.g., polygonal, conical, or rhomboidal. In one embodiment, the molded feed well 74 and the molded water well 70 form a rounded polygon shape, to prevent a caged animal from chewing on the wells 74, 70 and to maximize volume. Preferably, as indicated by R1 in FIG. 13, the corners of the wells 74, 70 are rounded and radiused to sufficiently prevent the animal from gripping parts of either well 74, 70 and chewing on the wells 74, 70. The rounded corners of the wells 74, 70 additionally facilitate mold release in manufacture.

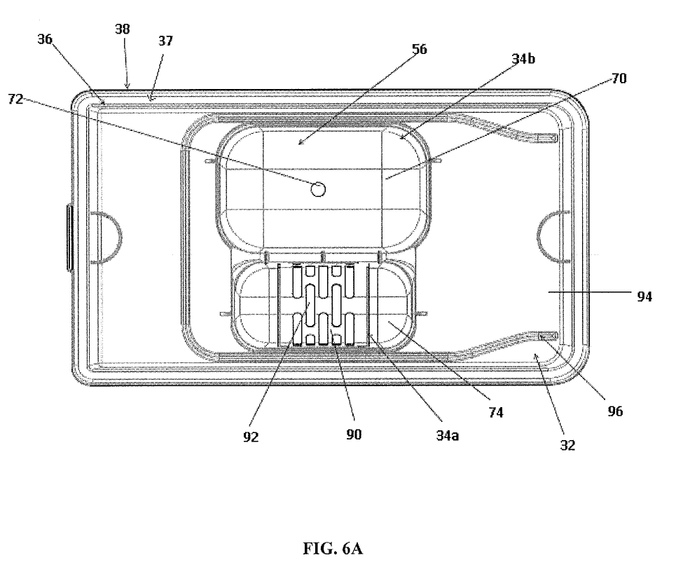

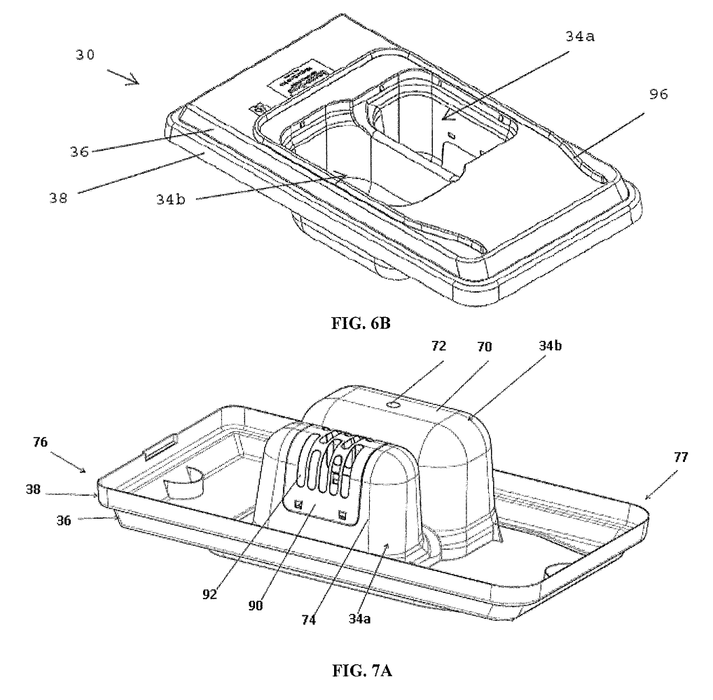

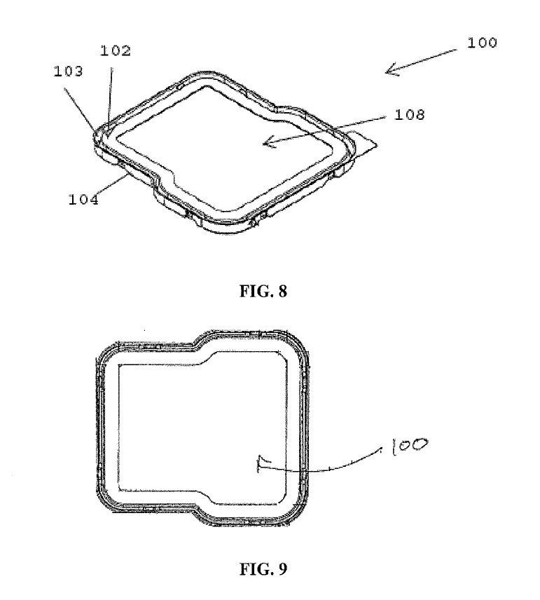

Reference is made to FIGS. 8-9 and 11 wherein a filter cover 100 is depicted. The filter cover 100 includes a support rim 102 preferably of the same clarified polypropylene material as the cage bottom and bonnet. A filter material 108 may preferably be heat-sealed to the rim 102. Rim 102 surrounds the entire filter assembly. Rim 102 includes wall 103 that has a U-shaped cross section that provides an outer peripheral wall 104. Outer peripheral wall 104 may be shaped to sit in the opening 56 (see FIG. 6A) on the top wall 32 of the bonnet 30, so that the filter cover 100 provides a filtered seal over the watering assembly 34b and feeding assembly 34a. The U-shaped cross section facilitates snapping the filter cover 100 onto the bonnet configuration 30 to assure a tight fit thereon.

On the top surface 94 of the bonnet configuration 30 is an elevated rib 96 that extends continually around the area in which the feeding assembly 34a and watering assembly 34b is disposed and extends to the end of the back end of the cage 10 to engage an exhaust valve in a high density rack. The rib 96 may be configured so that the top of the cage 10 when inserted into a canopy (see, e.g., FIG. 10) may be be positioned at or near the canopy in order to effect a substantial air seal between the canopy and the rib 96 of the bonnet configuration 30. The rib 96 terminates at the back edge of the cage 10 so that when the cage 10 is disposed in a canopy, it may register with an exhaust plenum in the rack.

Accordingly, in operation, when the cage 10 slides into the canopy, rib 96 may cause a sufficient air seal to create an improved negative pressure space so that when air is drawn into the plenum, the air may be be expelled from the cage bottom 11 through the filter cover 100 of the cage 10 and into the plenum.

In one embodiment, the cage bottom 11, bonnet configuration 30 (with the exception of closure 90) and filter cover 100, may all be made of polypropylene and may be injection molded to provide a lightweight barrier entry rodent cage that can be used to store different types of rodents. The cage 10 may also be molded to provide thinner walls than reusable type cages, which uses less material and reduces costs. Furthermore, polypropylene is easy to mold, lightweight and requires little energy to recycle. By utilizing the construction of the instant invention, and by using very inexpensive lightweight plastics such as clarified polypropylene, the disposable cages of the instant invention can be used for short periods of time, such as a day or a week or two, and not reused again. By using this type of cage, physical space for a washroom can be eliminated, the use of washroom employees is eliminated, and the cost of a study using such cages will be decreased. Also concerns relating to bacteria and toxins may remain on the cage after cleaning are eliminated.

Those skilled in the art will recognize that the method and system of the present invention has many applications, may be implemented in many manners and, as such is not to be limited by the foregoing embodiments and examples. Any number of the features of the different embodiments described herein may be combined into one single embodiment and alternate embodiments having fewer than or more than all of the features herein described are possible. Functionality may also be, in whole or in part, distributed among multiple components, in manners now known or to become known.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims. While there had been shown and described fundamental features of the invention as applied to being exemplary embodiments thereof, it will be understood that omissions and substitutions and changes in the form and details of the disclosed invention may be made by those skilled in the art without departing from the spirit of the invention. Moreover, the scope of the present invention covers conventionally known, future developed variations and modifications to the components described herein as would be understood by those skilled in the art. It is the intention, therefore, to be limited only as indicated by the scope of the claims appended hereto. It is also to be understood that the following claims are intended to cover all of the generic and specific features of the invention herein disclosed and all statements of the scope of the invention that, is a matter of language, might be said to fall therebetween.

1. A disposable cage system for housing animals comprising:
a cage bottom having a base, one or more side walls, and one or more end walls;
a bonnet configuration having a top wall with a top surface and a feeding assembly and a watering assembly integrally formed in the top wall, the feeding assembly and watering assembly defining an opening in the top surface; and
a removable filter cover.

2. The system of claim 1 wherein the cage bottom includes a peripheral top wall.

3. The system of claim 1 wherein the cage bottom includes a peripheral flange disposed around a an upper portion of the cage bottom and extending downward to create an outer skirt wall surrounding the periphery of the cage bottom.

4. The system of claim 1 wherein the cage bottom has a front portion and a back portion, wherein
one of the one or more side walls intersects one of the one or more end walls proximate the front portion to define a substantially rounded front corner having a front radius; and
one of the one or more side walls intersects one of the one or more end walls proximate the back portion to define a substantially rounded back corner having a back radius, wherein the back radius is greater than the front radius.

5. The system of claim 1 further comprising at least one grommet having one or more openings, the grommet disposed on either one of the one or more sidewalls or one of the one or more end walls of the cage bottom to permit air and/or water to pass into the cage bottom.

6. The system of claim 5 wherein the at least one grommet includes a first piece and a second piece, the first piece being engagable to the second piece.

7. The system of claim 5 wherein the at least one grommet is formed as a single piece.

8. The system of claim 1 further comprising at least one flap grommet including a displaceable flap, the flap grommet disposed either on one of the one or more sidewalls or one of the one or more end walls of the cage bottom and constructed and arranged to permit air and/or water to pass into the cage bottom.

9. The system of claim 8 wherein the at least one flap grommet includes an interior piece and an exterior piece, the exterior piece being engagable to the interior piece.

10. The system of claim 8 wherein the at least one flap grommet is formed as a single piece.

11. The system of claim 8 wherein the displaceable flap is made of a spring grade stainless steel.

12. The system of claim 1 wherein the bonnet configuration further includes an angled sidewall that terminates in a flat wall that extends downward to a skirt that surrounds the periphery of the top wall of the bonnet configuration.

13. The system of claim 1 wherein the watering assembly includes a molded well having an aperature for receiving a water container.

14. The system of claim 1 wherein the feeding assembly includes:
a molded well having an opening; and
a closure covering the opening for receiving food, the closure having one or more slots to enable a caged animal to obtain food from the feeding assembly.

15. The system of claim 14 wherein the closure of the feeding assembly includes at least four rows of slots with at least two slots per row.

16. The system of claim 15 wherein each slot has a length of approximately one inch.

17. The system of claim 14 wherein the closure is made of stainless steel.

18. The system of claim 1 wherein the bonnet configuration includes:
a front end and a back end; and
a rib disposed on the top surface of the top wall to create an air seal when the disposable cage system is placed in a ventilated rack system, the rib extending in a substantially U-shape around the feeding and watering assemblies and terminating proximate the back end of the bonnet configuration.

19. The system of claim 1 wherein the removable filter cover includes:
a support rim surrounding the periphery of the removable filter cover, the support rim having an included wall with a substantially U-shaped cross section and an outer peripheral wall, the filter cover constructed and arranged to selectively cover the opening in the top surface of the bonnet configuration; and
a filter material.

20. The system of claim 19 wherein the filter material is heat sealed to the support rim.

21. The system of claim 1 wherein the cage bottom is made of polypropylene.

22. The system of claim 1 wherein the bonnet configuration is at least partially made of polypropylene.

23. The system of claim 1 wherein the filter cover is at least partially made of polypropylene.

24. A disposable cage for housing animals configured to be used in ventilated rack and cage systems comprising:
a cage bottom including at least one side wall, at least one end wall, and a base;
a grommet disposed on one of the at least one end wall or side wall, the grommet configured to permit air from an air source or water from a water source to enter the cage bottom;
a bonnet configuration including:
a top wall;
a feeding assembly and a watering assembly defining an opening in the top wall;
a rib disposed on the top wall; and
a removable filter cover configured to selectively cover the opening in the top wall of the bonnet configuration.

25. A disposable cage system for housing animals comprising:
a cage bottom having
a base;
one or more side walls;
one or more end walls;
a peripheral top wall; and
a peripheral flange disposed around an upper portion of the cage bottom and extending downward to create an outer skirt wall surrounding the periphery of the cage bottom.

26. The system of claim 25 wherein the cage bottom has a front portion and a back portion, wherein:
one of the one or more side walls intersects one of the one or more end walls proximate the front portion to define a substantially rounded front corner having a front radius; and
one of the one or more side walls intersects one of the one or more end walls proximate the back portion to define a substantially rounded back corner having a back radius, wherein the back radius is greater than the front radius
